(19) United States
(12) Patent Application Publication
(10) Pub. No.: US 2015/0350369 A1
(43) Pub. Date: Dec. 3, 2015

(54) Method For Reducing Pre-Fetching Of Multimedia Streaming Data With Minimal Impact On Playback User Experience

(71) Applicant: QUALCOMM Incorporated, San Diego, CA (US)

(72) Inventors: Eyal David Ilsar, Rehovot (IL); Adam Jon Moore, San Francisco, CA (US); Shaul Kedem, Mevasseret Tzion (IL); Gabriel Berelejis, Mevasseret Tzion (IL)

(73) Assignee: QUALCOMM Incorporated, San Diego, CA (US)

(21) Appl. No.: 14/291,345

(22) Filed: May 30, 2014

(51) Int. Cl. H04L 29/08; H04L 29/06

(52) U.S. Cl. CPC H04L 67/2847; H04L 65/80; H04L 65/604

(57) ABSTRACT

Systems, methods, and devices of the various embodiments enable a receiver device to determine a high watermark margin and a low watermark margin for a cache based on data associated with a selected media instance and control the download of portions of the media instance based at least in part on the determined high watermark margin and low watermark margin. The high watermark margin and the low watermark margin may be determined based on a playback rate of the media instance and a high watermark margin time value and low watermark margin time value, respectively. The low watermark margin may be determined based on a rate of change in buffered portions of the media instance and the high watermark margin may be determined based on the determined low watermark margin and the playback rate.

### BACKGROUND

Increasingly people are viewing videos and movies on their mobile devices. Consequently, mobile operators are challenged to meet the exponentially increasing demand on their networks to support increases in traffic volume mainly contributed by audio and video streaming and consumption by smart phones users. Recent statistics on users' usage patterns when viewing videos on mobile devices reveal that most users abort playback of videos well before the videos are completed. The current media pre-fetchers used by applications, such as the pre-fetchers of the Android® platform used by applications including YouTube® and Pandora®, download a multimedia stream using all the available bandwidth and commonly over pre-fetch data that is likely not to be played by the user. Common solutions to this over pre-fetching of data are so called server side “pacing” techniques that throttle the streaming according to monitored network conditions from the server side. These server side solutions can be complicated to implement and can require costly server side network monitoring systems.

### SUMMARY

The systems, methods, and devices of the various embodiments enable a receiver device to determine a high watermark margin and a low watermark margin for a cache based on data associated with a selected media instance and control the download of portions of the media instance based at least in part on the determined high watermark margin and low watermark margin. In an embodiment, the high watermark margin and the low watermark margin may be determined based on a playback rate of the media instance and a high watermark margin time value and low watermark margin time value, respectively. In an embodiment, the high watermark margin time value and/or low watermark margin time value may be based on usage statistics, such as an abort pattern. In an embodiment, the low watermark margin may be determined based on a rate of change in buffered portions of the media instance and the high watermark margin may be determined based on the determined low watermark margin and the playback rate. In an embodiment, the high watermark margin and/or the low watermark margin may also be based at least in part on an about pattern coefficient. An abort pattern coefficient may be based on usage statistics and may be determined at a receiver device and/or received from a server.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 illustrates an example system architecture of a receiver device suitable for use with the various embodiments.

FIG. 3 is a block diagram of a media instance illustrating interactions between the media instance, a cache of a receiver device, a high watermark margin, and a low watermark margin according to an embodiment.

FIG. 4 is a process flow diagram illustrating an embodiment method for pre-fetching media on a receiver device.

FIG. 5 is a process flow diagram illustrating an embodiment method for controlling download of portions of a media instance to a cache based at least in part on a determined high watermark margin and a determined low watermark margin.

FIG. 6 is a process flow diagram illustrating an embodiment method for determining a high watermark margin and a low watermark margin for a cache of a receiver device based on data associated with a media instance.

FIG. 7 is a process flow diagram illustrating another embodiment method for determining a high watermark margin and a low watermark margin for a cache of a receiver device based on data associated with a media instance.

FIG. 8 is a process flow diagram illustrating a third embodiment method for determining a high watermark margin and a low watermark margin for a cache of a receiver device based on data associated with a media instance.

FIG. 9 is a process flow diagram illustrating an embodiment method for generating abort pattern coefficients and/or high watermark margin and low watermark margin time values based on usage statistics.

FIG. 10 is a component diagram of an example receiver device suitable for use with the various embodiments.

FIG. 11 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “receiver device” is used to refer to any one or all of cellular telephones, smart phones, personal or mobile multi-media players, personal data assistants (“PDAs”), personal computers, laptop computers, tablet computers, smart books, palm-top computers, wireless electronic mail receivers, multimedia Internet enabled cellular telephones, wireless gaming controllers, personal computers, television set top boxes, televisions, cable television receivers, and similar personal electronic devices which include a programmable processor and memory and circuitry for performing operations described herein, such as pre-fetching media.

The term “server” is used herein to refer to any computing device capable of functioning as a server, such as a master exchange server, web server, mail server, document server, content server, or any other type of server. A server may be a dedicated computing device or a computing device including a server module, such as an application that may cause a computing device to operate as a server. A server module (e.g., a server application) may be a full function server module, or a light or secondary server module (e.g., light or secondary server application) that is configured to provide synchronization services among the dynamic databases on mobile devices. A light server or secondary server may be a slimmed-down version of server-type functionality that can be implemented on a mobile device thereby enabling it to function as an Internet server (e.g., an enterprise e-mail server) only to the extent necessary to provide the functionality described herein.

As used herein the term “media instance” is used to refer to any type of media data that may be played back on a receiver device, such as video streaming data, audio streaming data, multimedia streaming data, etc. Media instances may include portions of data that may be downloaded to a receiver device and played back by an application or client running on a processor of the receiver device, such as video player (e.g., YouTube®), music player (e.g., Pandora®), web browser, etc. The portions of data making up a media instance may be downloaded by a pre-fetcher module, such as StageFright used in the Android® platform, to a cache and made available for play back by a client or application. While various embodiments and examples are discussed herein with reference to StageFright and the Android® platform, as well as applications or clients such as YouTube® or Pandora®, the discussions of StageFright, the Android® platform, YouTube®, and Pandora® are used merely as examples to better illustrate the aspects of the various embodiments, and are not intended to limit the scope of the claims. Other pre-fetchers, other platforms, such as the iOS® platform, and other applications or clients may be substituted in the various examples and embodiments without departing from the spirit or scope of the invention.

The systems, methods, and devices of the various embodiments enable a receiver device to determine a high watermark margin and a low watermark margin for a cache based on data associated with a selected media instance, and control the download of portions of the media instance based at least in part on the determined high watermark margin and low watermark margin. The various embodiments may provide a device side solution enabling the pre-fetching buffering algorithm to be changed to stop the download of portions of a media instance from overshooting the high watermark margin and/or undershooting the low watermark margin according to stream playback characteristics and monitored network conditions at the receiver device. By dynamically configuring the high watermark margin and/or the low watermark margin, the various embodiments may ensure that the size of the remaining data in the cache is maintained between the high watermark margin and the low watermark margin while maintaining continuous playback of a media instance from the cache. The various embodiments may provide receiver device implemented solutions to over pre-fetching of data that may be easier to integrate and lower cost than server implemented techniques that throttle the streaming according to monitored network conditions from the server side. The various embodiments, may unlink the size of the high watermark margin from the maximum size of the cache, and may reduce the amount of data that is pre-fetched at a time, thereby minimizing the amount of download bandwidth that may be consumed when the user aborts playback of a media instance before the media instance has ended.

In the various embodiments, the download state of portions of a media instance to a cache may be controlled by two limits, a low watermark margin and a high watermark margin. In the various embodiments, the high watermark margin may be a value representing a size offset (e.g., such as a byte offset) from the end of cache that may be less than the maximum cache size. In this manner, the high watermark margin may represent a goal of a maximal amount of buffered portions of a media instance ahead of the last access point stored in the cache. When the margin between the last access point and the end of cache (e.g., the buffered portions' size) reaches the high watermark margin, download of the media instance may be paused (e.g., by stopping download of the next portion of the undownloaded portions). In the various embodiments, the low watermark margin may be a value representing a size offset (e.g., such as a byte offset) from the end of cache that may be less than the high watermark margin. In this manner, the low watermark margin may represent the goal for the minimal amount of buffered portions of the media instance ahead of the last access point. When the margin between the last access point and the end of cache (e.g., the buffered portions' size) reaches the low watermark margin, download of the media instance may be commenced (or recommenced) (e.g., by requesting the next portion of the undownloaded portions of the media instance).

In an embodiment, the high watermark margin and the low watermark margin may be determined based on a playback rate of a media instance and a high watermark margin time value and low watermark margin time value, respectively. The playback rate of a media instance may be determined based on data associated with the media instance. For example, using the size and duration of a media instance as indicated in header information for the media instance, the playback rate may be determined as the size of the media instance divided by the duration of the media instance. In an embodiment, a high watermark margin time value and/or low watermark margin time value may be used in conjunction with the playback rate of a media instance to determine the high watermark margin and/or the low watermark margin, respectively. The high watermark margin time value may be a time value selected to account for a media player's time setting for resuming playback and may be stored in a memory of the receiver device. For example, the high watermark margin time value may be ten seconds.

In an embodiment, the high watermark margin may be determined by multiplying the high watermark margin time value by the determined playback rate of the media instance. The low watermark margin time value may be a time value selected to account for a media player's time setting for pausing playback and may be store in a memory of the receiver device. For example, the low watermark margin time value may be two seconds. In an embodiment, the low watermark margin may be determined by multiplying the low watermark margin time value by the determined playback rate of the media instance. Alternatively, the high watermark margin time value and/or the low watermark margin time value may be indicated in the header information of a media instance.

In an embodiment, initial default values of the high watermark margin and/or low watermark margin may be used when a media instance is first selected and/or at initial playback, and once the playback rate is determined, a new media instance specific high watermark margin and/or low watermark margin may be determined based on the determined playback rate and substituted for the initial default values of the high watermark margin and/or low watermark margin.

In various embodiments, receiver device behavior (and by extension user behavior) while playing-back the media instance may be tracked. For example, media instances may be aborted by the closing of a media player application or client that is playing the media instance, by the media player application or client suspending playback for a threshold period of time (e.g., in response to a user command to stop playback), or by the selection of a new media instance for playback by the application or client. Thus, a processor or server may determine when playback of a particular media instance has been aborted by detecting or recognizing any of these events during playback of the media instance. In an embodiment, the behavior (e.g., a playback abort) may be tracked by a processor of the receiver device performing operations to detect such events or other events or operations indicating that playback of a media instance has been aborted. In another embodiment, a server may be recognize (and thus track) playback abort behavior by recognizing and recording when requests for portions of a media instance cease before the complete media file has been delivered. A server may recognize that requests for portions of a media instance have ceased when the time since a last download request exceeds a threshold value (e.g., a predetermined time or the playback time of the last requested download), when a signal is received from a receiver device notifying the server that downloads should stop or that playback has been suspended, and/or when a download request is received from the receiver device for a different media instance before the complete media file has been delivered.

Parameters associated with the determined receiver device behavior in relation to media instance playback may be determined, such as abort parameters indicating a time from initial playback that a media instance was aborted. In an embodiment, the parameters (e.g., the abort parameters) may be determined at the receiver device. In another embodiment, the parameters (e.g., the abort parameters) may be determined at a server based on indications of determined receiver device behavior received from one or more receiver devices. These determined parameters may be used to update usage statistics associated with the receiver device and/or the media instance, such as an abort pattern indicating the average time at which playback was aborted.

The usage statistics (e.g., the abort pattern) may be specific to the media instance, such as the average time at which an abort occurs during playback of a particular media instance. Usage statistics specific to a media instance may also reflect other abort pattern details, such as the average time of abort at different times of day (e.g., morning, mid day and evening), the average time of abort in different geographic regions or locations, and average time of abort for different demographic categories if known (e.g., male vs. female, age group, etc.). Usage statistics specific to a media instance may also reflect the likelihood and timing of an abort occurring after a period of time playback. For example, viewers may frequently abort playback of a particular media instance within the first five minutes but rarely thereafter, as viewers either immediately dislike the media or watch the entire thing. As another example, some media instances may include a scene or segment during which many viewers abort playback (e.g., a scene or segment that many find to be offensive or boring), while the abort pattern for the rest of the media instance is consistent or average.

Additionally, the usage statistics (e.g., the abort pattern) may be related to the type or category of the media instance, such as an abort pattern for different types or genres of media based on behavior tracking of playback of media instances of various types or categories. Types or categories of media may be descriptions of attributes of the media instances used to group like media instances. Examples of types or categories may include, “advertising”, “movies”, “news”, “pop songs”, etc.

Further, the usage statistics (e.g., the abort pattern) may be generally related to the receiver device, such as an abort pattern indicating the average abort time of all media instances played back on a particular receiver device (which may be reflective of the abort pattern of the owner). Additionally, the usage statistics (e.g., the abort pattern) may be related to the receiver device and its handling of media instances of like types or categories, such as the average abort time of all media instances in a given category played back on the receiver device.

In an embodiment, the high watermark margin time value and/or low watermark margin time value may be based on usage statistics, such as an abort pattern associated with the media instance or the receiver device as described above. As an example, the high watermark margin time value and/or low watermark margin time value for a media instance may be determined at a server and provided to a receiver device as part metadata of a media instance (e.g., header information) or as part of a separate transmission. As another example, the high watermark margin time value and/or low watermark margin time value for the receiver device may be determined at the receiver device based on monitoring of media instance abort patterns at the receiver device.

In an embodiment, the low watermark margin may be determined based on a rate of change in buffered portions of the media instance. In an embodiment, the low watermark margin may be determined as a function of the rate of change in the buffered portions of the media instance in a cache of the receiver device. In an embodiment, the function may be a single function pre-provisioned at the receiver device and used for all media instances. In another embodiment, the function may be selected from a group of functions for determining a low watermark margin, with the selection based on a type or category of the media instance indicated in metadata of the media instance (e.g., a header).

In an embodiment, regardless of the results of the determination of the low watermark margin as a function of the rate of change in the buffered portions of the media instance in the cache, the low watermark margin may be constrained between a minimal low watermark margin value and a maximal low watermark margin value. For example, the minimal low watermark margin value may be 256K, while the maximal low watermark margin value may be 4M. The minimal and maximal low water mark margin values may be predetermined by a manufacturer or service provider, adjustable by a service provider (e.g., via an over-the-air update) or the user (e.g., in response to a user preference setting), or dynamically set by a service provider, a media provider (e.g., within a parameter field delivered as part of a media instance), by the receiver device (e.g., in response to detected link quality or playback conditions), or by the user.

In an embodiment, the high watermark margin may be determined based on the determined low watermark margin and the playback rate. In an embodiment, the high watermark margin may be equal to the low watermark margin plus a function of the playback rate. The playback rate may be determined as the size of the media instance divided by the duration of the media instance. In an embodiment, the function may be a single function pre-provisioned at the receiver device and used for all media instances. In another embodiment, the function may be selected from a group of functions for determining a high watermark margin, with the selection based on a type or category of the media instance indicated in metadata of the media instance (e.g., a header). In an embodiment, the high watermark margin and/or the low watermark margin may also be based at least in part on an abort pattern coefficient. In an embodiment, the function of the playback rate may be constrained by a minimal value, such as 1M.

In an embodiment, the high watermark margin and/or the low watermark margin may also be based at least in part on an abort pattern coefficient. For example, one or more abort pattern coefficients may be coefficients of the functions used for determining a low watermark margin and/or a high watermark margin. As described above, usage statistics may be determined at a receiver device and/or received from a server, and used to determine an abort pattern coefficient. In an embodiment, an abort pattern coefficient may be determined at a server and provided to a receiver device as part of the metadata of a media instance (e.g., within header information) or as part of a separate transmission. As another example, the abort pattern coefficient may be determined at the receiver device based on usage statistics received from another device (e.g., a server) and/or on usage statistics determined at the receiver device.

In an embodiment, the high watermark margin and/or low watermark margin may be re-determined or revised as portions of a media instance are downloaded, such as after each portion of the media instance is downloaded or after groups of portions of the media instance are downloaded. In this manner, the high watermark margin and/or low watermark margin may adapt to changes impacting the download of media instances, such as changes in the download rate, changes in the rate of change in the buffered portions of the media instance in a cache, etc. This embodiment may also enable the high watermark margin and/or low watermark margin may adapt to changes in the abort pattern for the media instance during playback. For example, the high watermark margin may be reduced just prior to and during a scene or segment at which point many viewers abort playback in order to conserve bandwidth since an abort is likely, and increased at other times to enhance playback. As another example, the high watermark margin may be increased as playback proceeds when abort patterns reflect that more viewers watch to the end the longer the playback proceeds.

In an embodiment, the operations to determine a high watermark margin and/or low watermark margin for a cache may be used across media instances as different media instances are selected for output on the receiver device. In an embodiment, downloaded portions of the media instance within the cache may be grouped together to support seeks in a media instance.

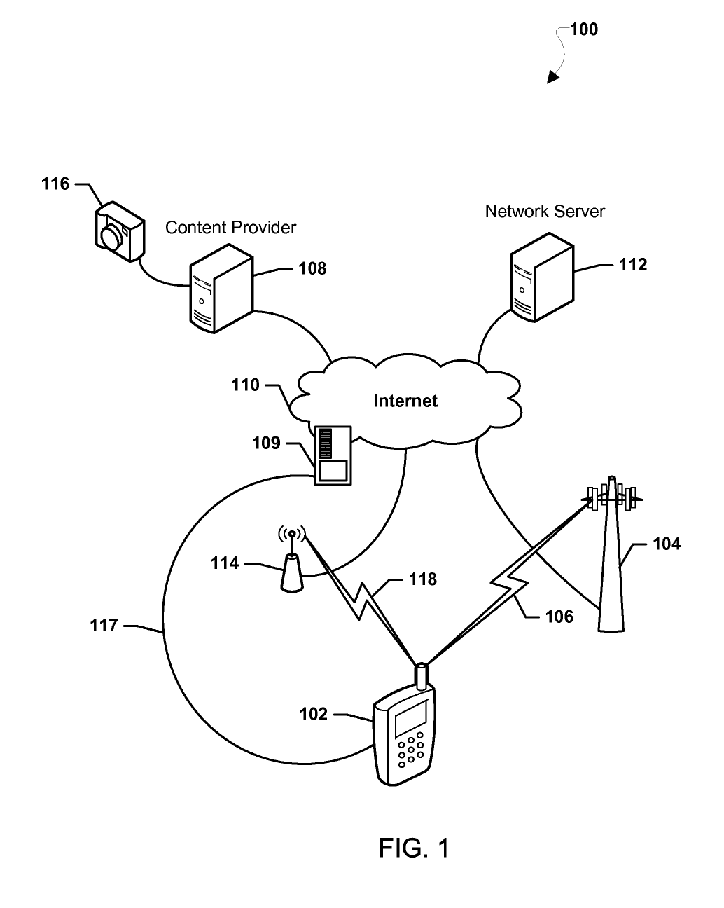

FIG. 1 illustrates a communication network system 100 suitable for use with the various embodiments. The communication network system 100 may include multiple devices, such as one or more receiver devices 102, one or more cellular towers or base stations 104, one or more wireless access point 114, one or more routers 109, and servers 108 and 112 connected to the Internet 110. The receiver devices 102 may exchange data via one or more cellular connections 106, including CDMA, TDMA, GSM, PCS, 3G, 4G, LTE, or any other type connection, with the cellular tower or base station 104. The cellular tower or base station 104 may be in communication with a router which may connect to the Internet 110. The receiver devices 102 may exchange data via one or more connections 118, including Wi-Fi® or any other type connection, with the wireless access point 114. The wireless access point 114 may be in communication with a router which may connect to the Internet 110. The receiver devices 102 may exchange data via one or more wired connections 117 with the router 109 which may connect to the Internet 110. In this manner, via the connections to the cellular tower or base station 104, wireless access point 114, router 109, and/or Internet 110, data may be exchanged between the receiver device 102 and the server(s) 108 and 112.

In an embodiment, server 108 may be a content provider server and/or encoder providing media instances for output (e.g., play back) via a client or application running on processors of the receiver devices 102. In an embodiment, the server 108 may receive the media from a media capture device 116, such as a camera, and encode the media into media instances (e.g., video, audio, or multimedia streams) configured to be output (e.g., played back) by a client or application running on processors of the receiver devices 102. Through various networks established using the Internet 110, router 109, wireless access point 114, and/or cellular tower or base station 104, the server 108 may provide media instances to the receiver devices 102. In an embodiment, server 112 may be a network server which may monitor network usage by the receiver devices 112, receive data associated with media instances and media instance consumption (e.g., abort parameters, usage statistics, etc.) from the receiver devices 102 and/or server 108, and send data associated with media instances and media instance consumption and/or network conditions to the receiver devices and/or server 108.

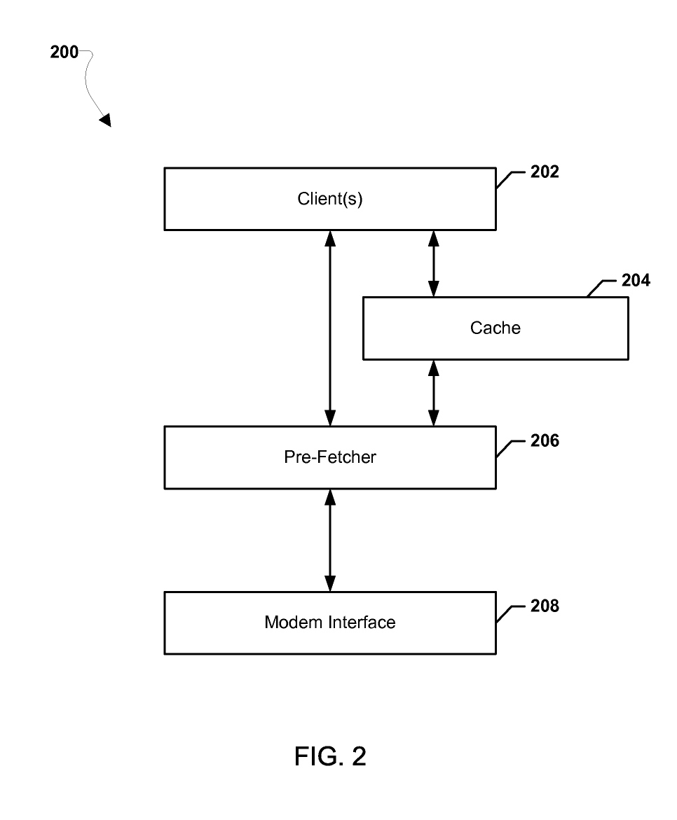

FIG. 2 illustrates an example system architecture 200 of a receiver device suitable for use with the various embodiments. The receiver device may include one or more clients 202 that may exchange data with a pre-fetcher module 206 and a memory configured to function as a cache 204 of the receiver device. The pre-fetcher module 206 may exchange data with the cache 204 and a modem interface 208 of the receiver device. A client 202, such as a YouTube® application, may send a media instance selection indication, such as a uniform resource indicator (URI), to the pre-fetcher module 206 in response to a media instance being selected for play back by a user of the receiver device (e.g., a user selection of “play” or “go” for a video or song). The pre-fetcher module 206, such as StageFright used in the Android® platform, may control the modem interface 208 to start downloading the portions of the media instance and as the portions of the media instance are received the pre-fetcher module 206 may store the portions of the media instance in the cache 204. The pre-fetcher module 206 may download the portions of the media instance and store the portions of the media instance in the cache 204 using any communication protocol, such as the Hypertext Transfer Protocol (HTTP) or any other communication protocol. The client 202 may consume the portions of the media instance by playing back portions of the media instance stored in the cache 204 to output the media instance on the receiver device.

The portions of the media instance in the cache 204 that have not yet been played back by the client 202 may be buffered portions of the media instance that change as new portions of the media instance are downloaded by the pre-fetcher module 206 to the cache 204 and portions of the media instance are played back from the cache 204 by the client 202.

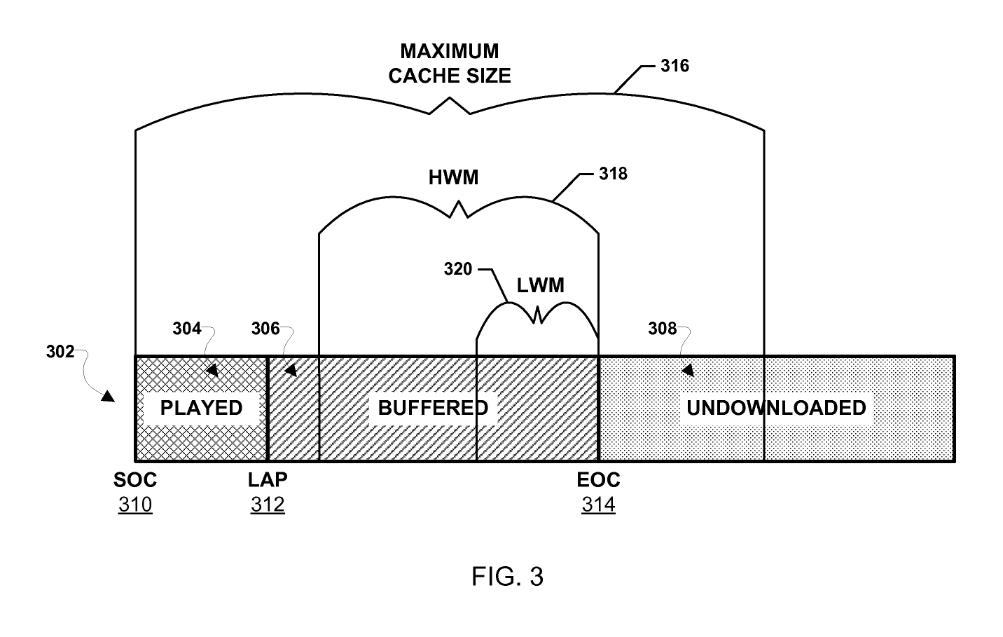

FIG. 3 is a block diagram of a media instance 302 illustrating embodiment interactions between the media instance 302, a cache of a receiver device, a high watermark margin (HWM) 318, and a low watermark margin (LWM) 320. At a given time a cache of the receiver device may store portions of the media instance 302. The portions of the media instance 302 in the cache may include portions that have been played back 304 (e.g., consumed by a client or application by displaying the video and/or outputting audio on the receiver device) and portions that are buffered 306 for playback (i.e., have not been consumed by the client or application). The portions that have been played back 304 may extend from the start of the cache (SOC) 310 (e.g., the oldest portion of the media instance 302 in the cache) to the last access point (LAP) 312 (e.g., the current portion of the media instance 302 being played back). The portions that are buffered 306 may extend from the last access point 312 to the end of the cache (EOC) 314 (e.g., the newest portion of the media instance 302 in the cache). Those portions of the media instance 302 that have not yet been downloaded to the cache may be undownloaded portions 308. The cache may have a maximum cache size 316 allocated to it, such as 5.0 MB, 20.0 MB, 100.0 MB, etc., and that may represent the maximum size of data that may be stored in the cache.

In the various embodiments, the download state of portions of the media instance 302 in the cache, as well as when media packets are downloaded and stored in the cache, may be controlled by two limits, the low watermark margin 320 and the high watermark margin 318.

In the various embodiments, the high watermark margin 318 may be a value representing a size offset (e.g., such as a byte offset) from the end of cache 314 that may be less than the maximum cache size 316. In this manner, the high watermark margin 318 may represent a goal of a maximal amount of buffered portions 306 ahead of the last access point 312 stored in the cache. When the margin between the last access point 312 and the end of cache 314 (e.g., the buffered portions' 306 size) reaches the high watermark margin 318, download of the media instance 302 may be paused (e.g., by stopping download of the next portion of the undownloaded portions 308).

In the various embodiments, the low watermark margin 320 may be a value representing a size offset (e.g., such as a byte offset) from the end of cache 314 that may be less than the high watermark margin 318. In this manner, the low watermark margin 320 may represent the goal for the minimal amount of buffered portions 306 ahead of the last access point 312. When the margin between the last access point 312 and the end of cache 314 (e.g., the buffered portions' 306 size) reaches the low watermark margin 320, download of the media instance 302 may be commenced (or recommenced) (e.g., by requesting the next portion of the undownloaded portions 308).

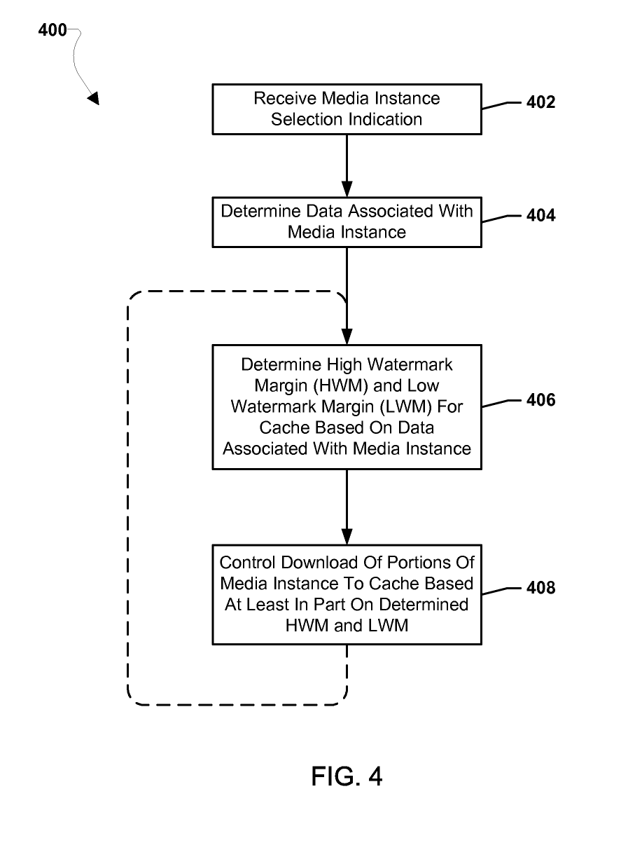

FIG. 4 illustrates an embodiment method 400 for pre-fetching media on a receiver device that may be performed by a processor of a receiver device, such as by a pre-fetcher module running on a processor of a receiver device. In block 402 the processor may receive a media instance selection indication. As an example, a media instance selection indication may be an indication received from a client application, such as a media player, of a selection of a video for output by the media player. The media instance selection indication may indicate an address, such as a URL, from which the media instance may be retrieved.

In block 404 the processor may determine data associated with the media instance. The data may include various information about the media instance including, a size of the media instance, a duration of the media instance, an abort pattern associated with the media instance, one or more abort pattern coefficients, a low watermark margin time value, a high watermark margin time value, a high watermark margin, a low watermark margin, a type or category of the media instance, and/or any other information about the media instance. In an embodiment, the processor may receive an initial portion of the requested media instance in response to requesting the media instance, and the initial portion may include data (e.g., metadata) associated with the media instance in a header. In an embodiment, the processor may determine the data associated with the media instance based at least in part on the data received in the initial portion of the media instance. In another embodiment, the processor may determine the data associated with the media instance based at least in part on data stored in a memory of the receiver device, such as one or more abort patterns, one or more abort pattern coefficients, etc. In a further embodiment, the processor may determine the data associated with the media instance based at least in part on a combination of data stored in a memory of the receiver device and data received in the initial portion of the media instance.

In block 406 the processor may determine a high watermark margin (HWM) and low watermark margin (LWM) for a cache of the receiver device based on data associated with the media instance. In an embodiment, the data associated with the media instance may be used to determine a playback rate of the media instance. In an embodiment, the high watermark margin for a cache of the receiver device may be determined based on a high watermark margin time value and the determined playback rate of the media instance and the low watermark margin for the cache of the receiver device may be determined based on a low watermark margin time value and the determined playback rate of the media instance. In another embodiment, the low watermark margin for a cache of the receiver device may be determined based at least in part on a rate of change in buffered portions of the media instance in the cache of the receiver device and the high watermark margin for the cache of the receiver device may be determined based at least in part on the low watermark margin and the determined playback rate. In a further embodiment, the low watermark margin and the high watermark margin may be determined based at least in part on an abort pattern or abort pattern coefficient associated with the media instance or the receiver device.

In block 408 the processor may control the download of portions of the media instance to the cache based at least in part on the determined high watermark margin and the determined low watermark margin. For example, the processor may begin downloading portions of the media instance when the size of the buffered portions of the media instance in the cache is less than or equal to the low watermark margin, may continue to download portions of the media instance while the size of the buffered portions of the media instance in the cache is less than the high watermark margin and the size of the buffered portions of the media instance is less than or equal to the low watermark margin, and may pause download of portions of the media instance when the size of the buffered portions of the media instance is greater than or equal to the high watermark margin. In an optional embodiment, the processor may return to block 406 to re-determine the high watermark margin and low watermark margin for the cache based on the data associated with the media instance. In this manner, the high and low watermark margins may be adjusted dynamically, thereby enabling the caching and downloading of portions of the media instance to be adaptively controlled as various parameter values change.

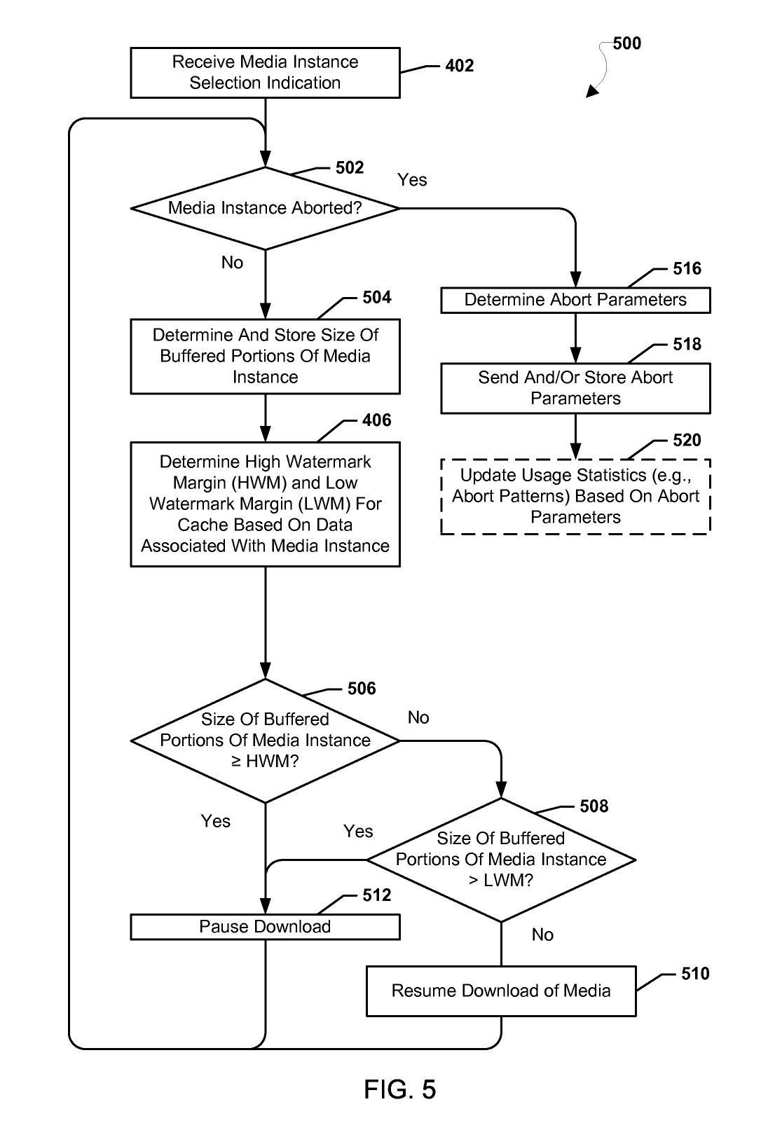

FIG. 5 illustrates an embodiment method 500 for controlling the download of portions of a media instance to a cache based at least in part on a determined high watermark margin and a determined low watermark margin. In an embodiment, the operations of method 500 may be performed by a processor of a receiver device, such as by a pre-fetcher module running on a processor of a receiver device.

As described above, in block 402 the processor may receive a media instance selection indication. In determination block 502 the processor may determine whether the media instance is aborted. A media instance may be aborted in various manners, such as by the media viewing application or client being closed, a new media instance selection indication being received, etc. This iterative process (which starts in block 502) occurs in sync with the playback that occurs in parallel to the process in method 400 described above with reference to FIG. 4.

In response to determining that the media instance is not aborted (i.e., determination block 502=“No”), the processor may determine and store a size of the buffered portions of the media instance in the cache of the receiver device in block 504. The buffered portions of the media instance in the cache of the receiver device may be those portions stored in the cache but not yet played back by the client or application outputting the media instance. The processor may determine the size of the buffered portions of the media instance in the cache by analyzing the contents of the cache of the receiver device and may store the determined size of the buffered portions of the media instance in the cache of the receiver device, for example by overwriting a previous determined size of the buffered portions of the media instance.

As described above, in block 406 the processor may determine the high watermark margin and the low watermark margin for the cache based on data associated with the media instance. In determination block 506, the processor may determine whether the size of the buffered portions of the media instance in the cache is greater than or equal to the high watermark margin. For example, the processor may compare the value of the determined size of the buffered portions of the media instance stored in the cache to the high watermark margin to determine whether the size of the buffered portions of the media instance is greater than or equal to the high watermark margin. In response to determining that the size of the buffered portions of the media instance in the cache is less than the high watermark margin (i.e., determination block 506=“No”), the processor may determine whether the size of the buffered portions of the media instance in the cache is greater than the low watermark margin in determination block 508. For example, the processor may compare the value of the determined size of the buffered portions of the media instance stored in the cache to the low watermark margin to determine whether the size of the buffered portions of the media instance is greater than the low watermark margin.

In response to determining that the size of the buffered portions of the media instance in the cache is less than or equal to the low watermark margin (i.e., determination block 508=“No”), the processor may resume download (i.e., prefetching) of the media instance to the cache in block 510, thus downloading/prefetching the next portion of the media instance. For example, the processor may resume downloading the media by sending a request, such as a Get( ) request, for the next portion of the media instance and in response may receive the next portion of the media instance and store the data in the cache. Upon downloading the next portion of the media instance to the cache in block 510, the processor may again determine whether the media instance is aborted in determination block 502, and in response to determining that the media instance is not aborted (i.e., determination block 502=“No”), the processor may determine and store an new size of the buffered portions of the media instance in block 504, determine a new high watermark margin and low watermark margin for the cache based on the data associated with the media instance in block 406, and determine whether the size of the buffered portions of the media instance is greater than or equal to the high watermark margin in determination block 506.

In response to determining that the size of the buffered portions of the media instance in the cache is greater than or equal to the high watermark margin (i.e., determination block 506=“Yes”), the download/prefetch of portions of the media instance may be paused in block 512. In subsequent iterations when download has been paused while playback continues from the buffer and the size of the buffered portions of the media instance is less than the high watermark margin (i.e., determination block 506=“Yes”) but the size of the buffered portions of the media instance remains greater than the low watermark margin (i.e., determination block 508=“Yes”), download/prefetch of the media may remain paused in block 512.

The receiver device processor performs the operations of method 500 in a loop so that as long as the media instance is not aborted (i.e., so long as determination block 502=“No”), the processor may continually determine whether the size of the buffered portions of the media instance in the cache is above the high watermark margin or below the low watermark margin, with downloading (i.e., prefetching) pausing in block 512 when the size of the buffered portions of the media instance in the cache is greater than or equal to the high water mark (i.e., determination block 506=“Yes”) and resuming when the size of the buffered portions of the media instance in the cache is less than the low water mark (i.e., determination block 508=“No”). In other words, download and playback occur simultaneously with blocks 510 and 512 providing a pause and resume mechanism for controlling the pre-fetching of portions of the media instance based on the size of the buffered portions of the media instance in the cache and the determined high watermark margin and low watermark margin until the media instance is fully downloaded or playback aborted. Thus, the low watermark margin is used to determine when to resume downloading (i.e., prefetching) in order to ensure sufficient data is buffered in the cache to avoid stalls in playback of the media instance, while the high watermark margin is used to determine when to pause downloading in order to guard against over buffering of the media instance.

In response to determining that the media instance has been aborted (i.e., determination block 502=“Yes”), the processor may determine abort parameters in block 516. Abort parameters may include the time from start of playback at which the abort occurred, a type or category of the media instance, and/or other data related to the consumption of the media instance by the receiver device and/or the media instance itself, as well as other parameters described herein. Abort parameters may be used by the receiver device and/or by remote devices, such as a remote server, to generate/update usage statistics (e.g., abort patterns) associated with media instances and/or receiver devices. In block 518 the processor may send and/or store the abort parameters. As an example, the processor may send the abort parameters to a remote device, store the abort parameters in a memory of the receiver device, and/or send the abort parameters to another application running on the receiver device processor. In optional block 520 the processor may update usage statistics (e.g., abort patterns) based on the abort parameters. For example, an average time since the start of playback at which media instances are aborted may be updated based on the newly determined abort parameters.

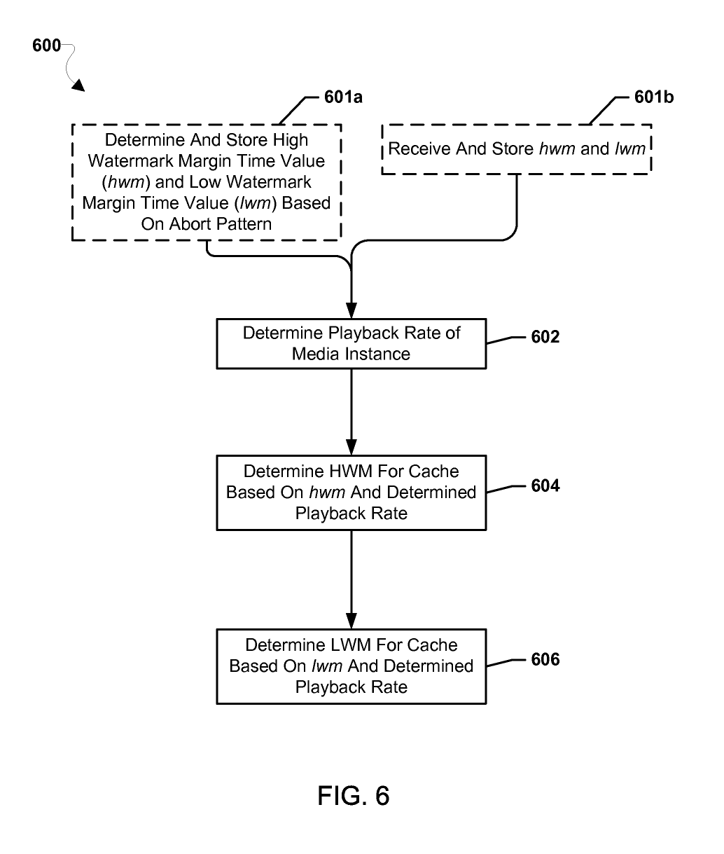

FIG. 6 illustrates an embodiment method 600 for determining a high watermark margin and a low watermark margin for a cache of a receiver device based on data associated with a media instance. In an embodiment, the operations of method 600 may be performed by a processor of a receiver device, such as by a pre-fetcher module running on a processor of a receiver device. In an embodiment, the operations of method 600 may be performed in conjunction with the operations of methods 400 or 500 described above.

As discussed above, a high watermark margin time value (hwm) and/or low watermark margin time value (lwm) may be determined at a receiver device or may be determined remote from the receiver device (e.g., at a server) and provided to the receiver device. Therefore, in an optional embodiment, in block 601a the processor may determine and store the high watermark margin time value and the low watermark margin time value based on an abort pattern. The abort pattern may be associated with a media instance or the receiver device. In an alternate optional embodiment, in block 601b the processor may receive and store the high watermark margin time value and the low watermark margin time value. For example, the processor may receive the high watermark margin time value and the low watermark margin time value from a remote server and may store the values in a memory of the receiver device. Regardless of whether determined by the receiver device in block 601a or received by the receiver device in block 601b, the low watermark margin time value may be a time set to account for the pausing of playback by a media player (e.g., 2 seconds) and the high watermark margin time value may be a time set to account for resuming of playback by a media player (e.g., 10 seconds).

In block 602 the processor may determine a playback rate of the media instance. For example, the playback rate may be based on a size (Size) and duration (Duration) of the media instance extracted from media instance headers. The playback rate (R_{playback}) may then be calculated according to the equation:

$$\frac{d Playback ( t )}{d t} = \frac{Size}{Duration} = {R}_{playback}$$

In block 604 the processor may determine the high watermark margin for the cache of the receiver device based on the high watermark margin time value and the determined playback rate of the media instance. For example, using the value of the high watermark margin time value (hwm) and the playback rate (Rplayback), the high watermark margin (HWM) may be calculated according to the equation:

HWM=hwm×R_{playback}

In block 606 the processor may determine the low watermark margin for the cache of the receiver device based on the low watermark margin time value and the determined playback rate of the media instance. For example, using the value of the low watermark margin time value (lwm) and the playback rate (Rplayback), the low watermark margin (LWM) may be calculated according to the equation:

LWM=lwm×R_{playback}

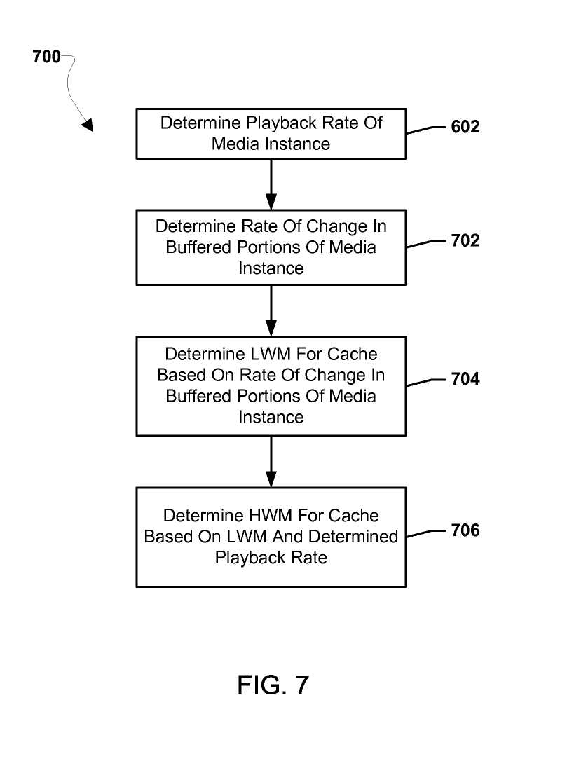

FIG. 7 illustrates an embodiment method 700 for determining a high watermark margin and a low watermark margin for a cache of a receiver device based on data associated with a media instance. In an embodiment, the operations of method 700 may be performed by a processor of a receiver device, for example by a pre-fetcher module running on a processor of a receiver device. In an embodiment, the operations of method 700 may be performed in conjunction with the operations of methods 400 or 500 described above.

As described above with reference to FIG. 6, in block 602 the processor may determine the playback rate of the media instance. In block 702 the processor may determine a rate of change in the buffered portions of a media instance in a cache of the receiver device. As an example, the rate of change in the buffered portions of a media instance

$$( \frac{d Remaining ( t )}{d t} )$$

may be determined by comparing the amount of buffered portions of a media instance in the cache when a current portion request is sent to the amount of buffered portions of a media instance in the cache when a last portion request was sent. As requests for portions of a media instance (e.g., Get( ) requests), are sent the processor may store the size of the buffered portions of the media instance in the cache with a timestamp of the request. In this manner, the rate of change of the buffered portions of the media instance in the cache may be determined by dividing the change in buffered portion size by the time interval between requests determined based on the different timestamps. Alternatively, requests may be sent at a constant periodicity, and timestamps may not be required, in which case the change in the size of the buffered portion may be divided by the periodicity to determine the rate of change in the buffered portions of a media instance.

In block 704 the processor may determine a low watermark margin for the cache of the receiver device based at least in part on the rate of change in the buffered portions of the media instance in the cache of the receiver device. As an example, the low watermark margin (LWM) may be determined as a function (ƒ₁) of the rate of change in the buffered portions of a media instance

$$( \frac{d Remaining ( t )}{d t} )$$

according to the equation:

$$LWM = {f}_{1} ( \frac{d Remaining ( t )}{d t} )$$

In an embodiment, the function (ƒ₁) may be a function stored in a memory of the receiver device used for all media instances. In another embodiment, the function (ƒ₁) may be a function selected from a group of functions stored in a memory of the received device based on attributes of the media instance, such as a type or category. In an embodiment, the value of the low watermark margin may be constrained between a minimal value (e.g., 256K) and a maximal value (e.g., 4M), regardless of the result of function (ƒ₁).

In block 706 the processor may determine the high watermark margin for the cache of the receiver device based at least in part on the low watermark margin and the determined playback rate. As an example, the high watermark margin (HWM) may be determined as the low watermark margin (LWM) plus a function (ƒ₂) of the playback rate (Rplayback) according to the equation:

HWM=LWM+ƒ₂(Rplayback)

In an embodiment, the function (ƒ₂) may be a function stored in a memory of the receiver device used for all media instances. In another embodiment, the function (ƒ₂) may be a function selected from a group of functions stored in a memory of the received device based on attributes of the media instance, such as a type or category. In an embodiment, the value of ƒ₂ (Rplayback) may be constrained to be at least a minimal value (e.g., 1M).

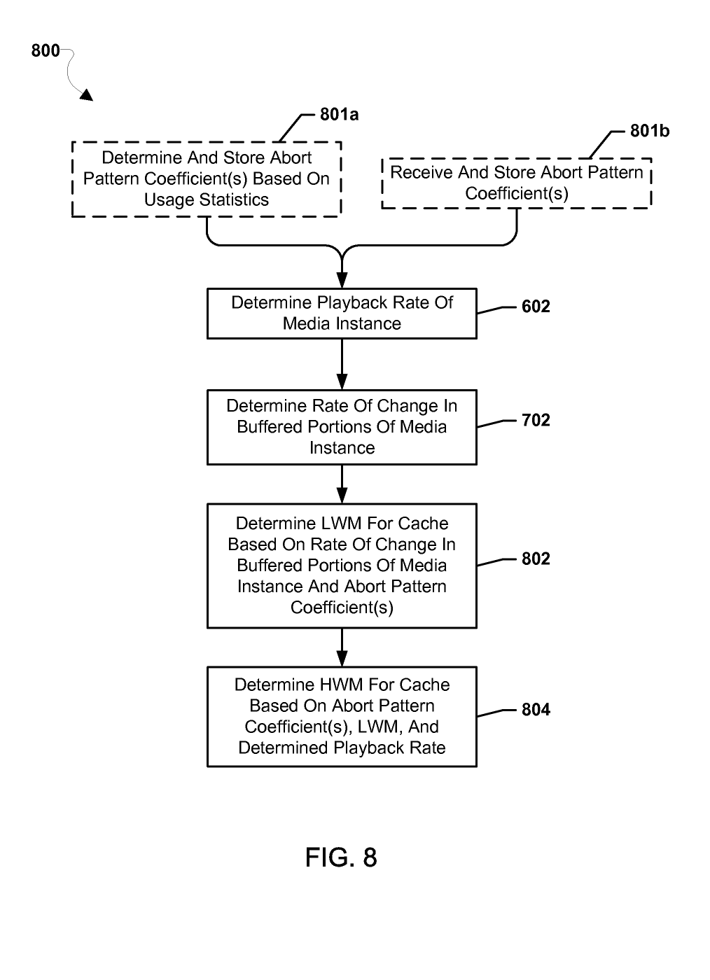

FIG. 8 illustrates an embodiment method for determining a high watermark margin and a low watermark margin for a cache of a receiver device based on data associated with a media instance. In an embodiment, the operations of method 700 may be performed by a processor of a receiver device, such as by a pre-fetcher module running on a processor of a receiver device. In an embodiment, the operations of method 700 may be performed in conjunction with the operations of methods 400 or 500 described above.

As discussed above, abort pattern coefficients may be determined by a receiver device or may be determined by a computer remote from the receiver device (e.g., by a server) and provided to the receiver device. Therefore, in an optional embodiment, in block 801a the processor may determine and store one or more abort pattern coefficients based on usage statistics available to the receiver device. The abort pattern may be associated with a media instance or the receiver device. In an alternate optional embodiment, in block 801b the processor may receive and store one or more abort pattern coefficients. For example, the processor may receive the one or more abort pattern coefficients from a remote server and may store the coefficients in a memory of the receiver device.

As described above, in block 602 the processor may determine a playback rate of the media instance, and in block 702 the processor may determine a rate of change in the buffered portions of the media instance. In block 802 the processor may determine the low watermark margin for the cache of the receiver device based at least in part on the rate of change in the buffered portions of the media instance in the cache of the receiver device and the abort pattern coefficient(s). For example, one or more abort coefficient may be coefficients of function ƒ₁ discussed above with reference to block 704 of FIG. 7. In this manner, the determined low watermark margin may vary based on the abort pattern coefficients.

In block 804 the processor may determine the high watermark margin for the cache of the receiver device based at least in part on the abort pattern coefficient(s), the low watermark margin, and the determined playback rate. For example, one or more abort coefficients may be coefficients of function ƒ₁ or function ƒ₂ discussed above with reference to blocks 704 and 706 of FIG. 7. In this manner, the determined high watermark margin may vary based on the abort pattern coefficients.

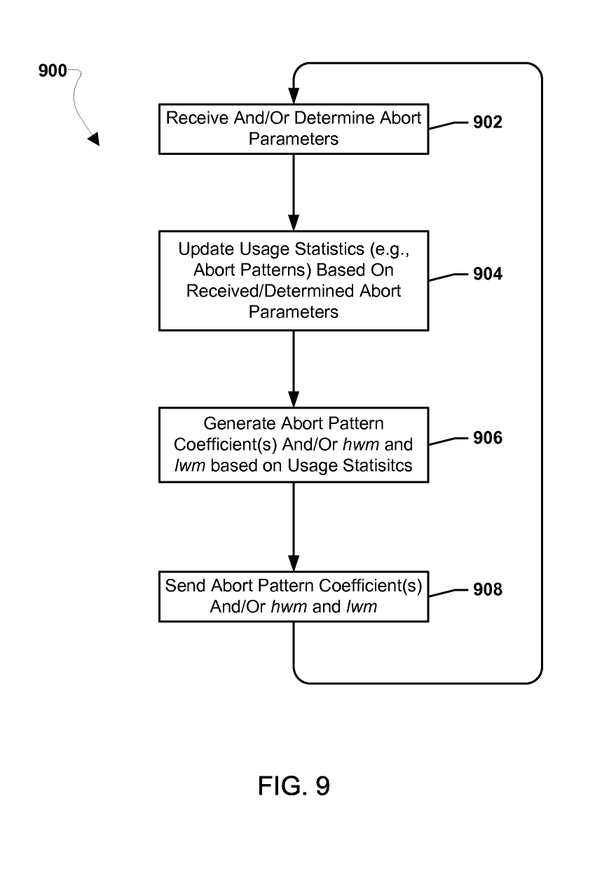

FIG. 9 illustrates an embodiment method for generating abort pattern coefficients and/or high watermark margin and low watermark margin time values based on usage statistics. In an embodiment, the operations of method 900 may be performed by a server remote from the receiver device, such as a network server or content provider server. In an embodiment, the operations of method 900 may be performed in conjunction with the operations of methods 400, 500, 600, and/or 800 described above.

In block 902 the server may receive and/or determine abort parameters. In an embodiment, the server may receive abort parameters from a number of receiver devices outputting a particular media instance. In another embodiment, the server may determine abort parameters by monitoring the download of portions of a media instance by a number of receiver devices, such as to determine the last portion requested by a receiver device. In this manner, the server may identify when media instances are aborted on receiver devices. In block 904 the processor may update usage statistics (e.g., abort patterns) based on the received/determined abort parameters. For example, the server may track the average abort time for a media instance specifically and/or for a type or category of media instance. As new abort parameters are received, the usage statistics may be updated based on the growing data set of abort parameters.

In block 906 the server may generate abort pattern coefficients and/or high watermark margin time values and low watermark margin time vales based on the usage statistics. In block 908 the server may send the abort pattern coefficients and or high watermark margin time values and low watermark margin time vales to receiver devices. In an embodiment, the abort pattern coefficients and or high watermark margin time values and low watermark margin time vales may be sent to receiver devices independent of a request for a media instance, such as in overhead signaling information for a media service. In another embodiment, the abort pattern coefficients and or high watermark margin time values and low watermark margin time vales may be included in metadata (e.g., within header information) for a media instance and provided with the media instance to the receiver device.

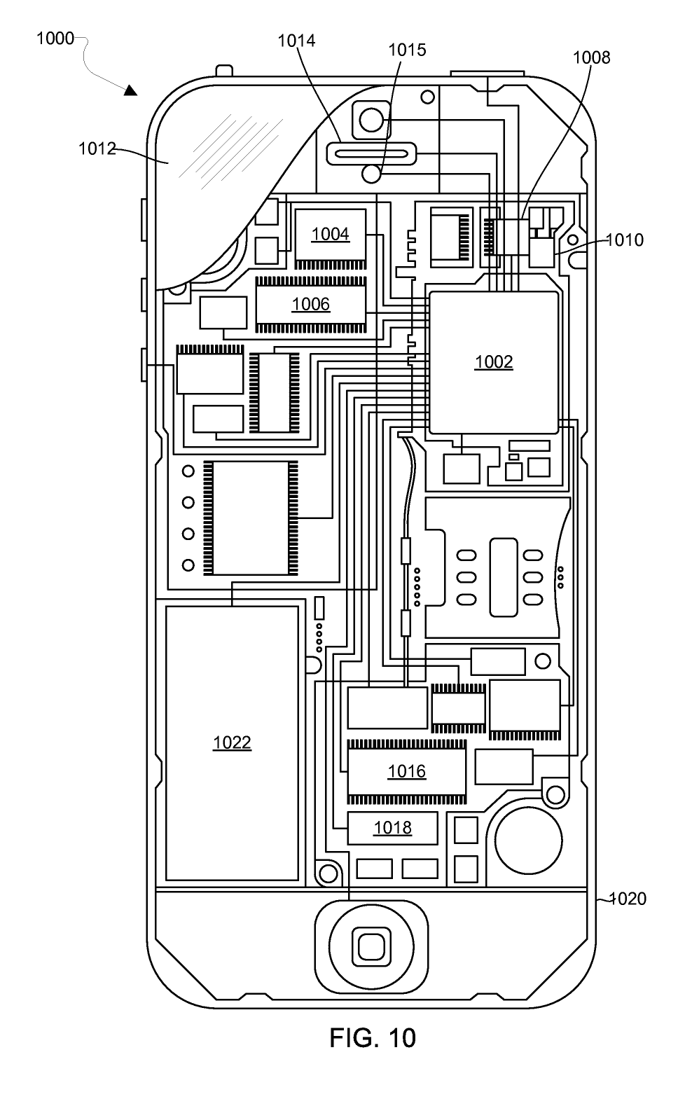

The various embodiments may be implemented in any of a variety of receiver devices, an example of which is illustrated in FIG. 10. For example, the receiver device 1000 may include a processor 1002 coupled to internal memories 1004 and 1006, one or more of which may be configured to function as buffers for storing portions of prefetched media instances as described. Internal memories 1004 and 1006 may be volatile or non-volatile memories, and may also be secure and/or encrypted memories, or unsecure and/or unencrypted memories, or any combination thereof. The processor 1002 may also be coupled to a touch screen display 1012, such as a resistive-sensing touch screen, capacitive-sensing touch screen infrared sensing touch screen, or the like. Additionally, the display of the receiver device 1000 need not have touch screen capability. The receiver device 1000 may have one or more radio signal transceivers 1008 (e.g., Peanut®, Bluetooth®, Zigbee®, Wi-Fi, RF radio) and antennae 1010, for sending and receiving, coupled to the processor 1002. The receiver device 1000 may include a network interface 1016, such as wireless modem chip, that enables communication via a data network (e.g., CDMA, TDMA, GSM, PCS, 3G, 4G, LTE, or any other type of data network) and is coupled to the processor 1002. The network interface 1016 may be configured to receive downloaded portions of prefetched media instances as described. The receiver device 1000 may include a peripheral device connection interface 1018 coupled to the processor 1002. The peripheral device connection interface 1018 may be singularly configured to accept one type of connection, or multiply configured to accept various types of physical and communication connections, common or proprietary, such as USB, FireWire, Thunderbolt, PCIe, etc. The peripheral device connection interface 1018 may also be coupled to a similarly configured peripheral device connection port, and the peripheral device connection interface 1018 may operate as a network interface to connect the receiver device 1000 and processor 1002 to various networks. In some embodiments, the peripheral device connection interface 1018 may be configured to receive downloaded portions of prefetched media instances as described. The receiver device 1000 may also include speakers 1014 for providing audio outputs and microphones 1015 for receiving audio inputs. The receiver device 1000 may also include a housing 1020, constructed of a plastic, metal, or a combination of materials, for containing all or some of the components discussed herein. The receiver device 1000 may include a power source 1022 coupled to the processor 1002, such as a disposable or rechargeable battery. The rechargeable battery may also be coupled to the peripheral device connection port to receive a charging current from a source external to the receiver device 1000.

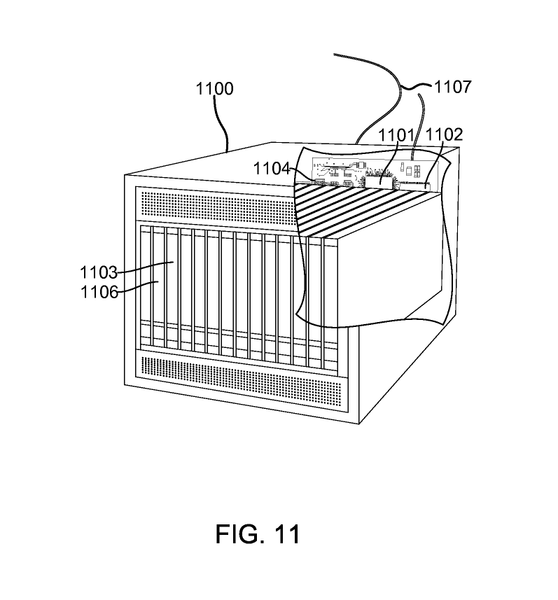

The various embodiments may also be implemented on any of a variety of commercially available server devices, such as the server 1100 illustrated in FIG. 11. Such a server 1100 typically includes a processor 1101 coupled to volatile memory 1102 and a large capacity nonvolatile memory, such as a disk drive 1103. The server 1100 may also include a floppy disc drive, compact disc (CD) or DVD disc drive 1106 coupled to the processor 1101. The server 1100 may also include network access ports 1104 coupled to the processor 1101 for establishing network interface connections with a network 1107, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 1002 and 1101 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 1004, 1006, 1102, and 1103 before they are accessed and loaded into the processors 1002 and 1101. The processors 1002 and 1101 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1002 and 1101 including internal memory or removable memory plugged into the device and memory within the processor 1002 and 1101 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for pre-fetching a media instance on a receiver device, comprising:
determining, in a processor of the receiver device, a high watermark margin and a low watermark margin for a cache of the receiver device based on data associated with a media instance to be downloaded; and
controlling, in the processor, download of portions of the media instance to the cache based at least in part on the determined high watermark margin and the determined low watermark margin.

2. The method of claim 1, wherein determining, in the processor, the high watermark margin and the low watermark margin for the cache of the receiver device based on data associated with the media instance to be downloaded comprises:
determining, in the processor, a playback rate of the media instance based on data associated with the media instance in response to receiving a media instance selection indication;
determining, in the processor, the high watermark margin for the cache of the receiver device based on a high watermark margin time value and the determined playback rate of the media instance; and
determining, in the processor, the low watermark margin for the cache of the receiver device based on a low watermark margin time value and the determined playback rate of the media instance.

3. The method of claim 2, wherein the high watermark margin time value and the low watermark margin time value are based at least in part on an abort pattern associated with the media instance or the receiver device.

4. The method of claim 1, wherein determining, in the processor, the high watermark margin and the low watermark margin for the cache of the receiver device based on data associated with the media instance to be downloaded comprises:
determining, in the processor, a playback rate of the media instance based on data associated with the media instance in response to receiving a media instance selection indication;
determining, in the processor, the low watermark margin for the cache of the receiver device based at least in part on a rate of change in buffered portions of the media instance in the cache of the receiver device; and
determining, in the processor, the high watermark margin for the cache of the receiver device based at least in part on the low watermark margin and the determined playback rate.

5. The method of claim 4, wherein determining, in the processor, the high watermark margin for the cache of the receiver device based at least in part on the low watermark margin and the determined playback rate comprises determining, in the processor, the high watermark margin for the cache of the receiver device based at least in part on an abort pattern coefficient, the low watermark margin, and the determined playback rate.

6. The method of claim 5, wherein determining, in the processor, the low watermark margin for the cache of the receiver device based at least in part on a rate of change in buffered portions of the media instance in the cache of the receiver device comprises determining, in the processor, the low watermark margin for the cache of the receiver device based at least in part on a rate of change in buffered portions of the media instance in the cache of the receiver device and the abort pattern coefficient.

7. The method of claim 5, further comprising, determining, in the processor, the abort pattern coefficient based on usage statistics of the receiver device.

8. The method of claim 5, further comprising receiving the abort pattern coefficient from a server, wherein the abort pattern coefficient is based at least in part on usage statistics of other receiver devices.

9. A receiver device, comprising:
a cache configured to buffer portions of media instances;
a network interface configured to receive prefetched portions of media instances; and
a processor coupled to the cache and the network interface and configured with processor-executable instructions to perform operations comprising:
determining a high watermark margin and a low watermark margin for the cache based on data associated with a media instance to be downloaded; and
controlling download of portions of the media instance to the cache based at least in part on the determined high watermark margin and the determined low watermark margin.

10. The receiver device of claim 9, wherein determining a high watermark margin and a low watermark margin for the cache based on data associated with the media instance to be downloaded comprises:
determining a playback rate of the media instance based on data associated with the media instance in response to receiving a media instance selection indication;
determining the high watermark margin for the cache based on a high watermark margin time value and the determined playback rate of the media instance; and
determining the low watermark margin for the cache based on a low watermark margin time value and the determined playback rate of the media instance.

11. The receiver device of claim 10, wherein the high watermark margin time value and the low watermark margin time value are based at least in part on an abort pattern associated with the media instance or the receiver device.

12. The receiver device of claim 9, wherein determining a high watermark margin and a low watermark margin for the cache based on data associated with the media instance to be downloaded comprises:
determining a playback rate of the media instance based on data associated with the media instance in response to receiving a media instance selection indication;
determining the low watermark margin for the cache based at least in part on a rate of change in buffered portions of the media instance in the cache; and
determining the high watermark margin for the cache based at least in part on the low watermark margin and the determined playback rate.

13. The receiver device of claim 12, wherein determining the high watermark margin for the cache based at least in part on the low watermark margin and the determined playback rate comprises determining the high watermark margin for the cache based at least in part on an abort pattern coefficient, the low watermark margin, and the determined playback rate.

14. The receiver device of claim 13, wherein determining the low watermark margin for the cache based at least in part on a rate of change in buffered portions of the media instance in the cache comprises determining the low watermark margin for the cache based at least in part on a rate of change in buffered portions of the media instance in the cache and the abort pattern coefficient.

15. The receiver device of claim 13, further comprising determining the abort pattern coefficient based on usage statistics of the receiver device.

16. The receiver device of claim 13, further comprising receiving the abort pattern coefficient from a server, wherein the abort pattern coefficient is based at least in part on usage statistics of other receiver devices.

17. A receiver device, comprising:
a cache configured to buffer portions of media instances;
means for determining a high watermark margin and a low watermark margin for the cache based on data associated with a media instance to be downloaded; and
means for controlling download of portions of the media instance to the cache based at least in part on the determined high watermark margin and the determined low watermark margin.

18. The receiver device of claim 17, wherein means for determining the high watermark margin and the low watermark margin for the cache based on data associated with the media instance to be downloaded comprises:
means for determining a playback rate of the media instance based on data associated with the media instance in response to receiving a media instance selection indication;
means for determining the high watermark margin for the cache based on a high watermark margin time value and the determined playback rate of the media instance; and
means for determining the low watermark margin for the cache based on a low watermark margin time value and the determined playback rate of the media instance,
wherein the high watermark margin time value and the low watermark margin time value are based at least in part on an abort pattern associated with the media instance or the receiver device.

19. The receiver device of claim 17, wherein means for determining the high watermark margin and the low watermark margin for the cache based on data associated with the media instance to be downloaded comprises:
means for determining a playback rate of the media instance based on data associated with the media instance in response to receiving a media instance selection indication;
means for determining the low watermark margin for the cache based at least in part on a rate of change in buffered portions of the media instance in the cache; and
means for determining the high watermark margin for the cache of the receiver device based at least in part on the low watermark margin and the determined playback rate.

20. The receiver device of claim 19, wherein means for determining the high watermark margin for the cache based at least in part on the low watermark margin and the determined playback rate comprises means for determining the high watermark margin for the cache of the receiver device based at least in part on an abort pattern coefficient, the low watermark margin, and the determined playback rate.

21. The receiver device of claim 20, wherein means for determining a low watermark margin for the cache based at least in part on a rate of change in buffered portions of the media instance in the cache comprises means for determining a low watermark margin for the cache based at least in part on a rate of change in buffered portions of the media instance in the cache and the abort pattern coefficient.

22. The receiver device of claim 20, further comprising means for determining the abort pattern coefficient based on usage statistics of the receiver device.

23. The receiver device of claim 20, further comprising means for receiving the abort pattern coefficient from a server, wherein the abort pattern coefficient is based at least in part on usage statistics of other receiver devices.

24. A non-transitory processor-readable storage medium having stored thereon processor-executable instructions configured to cause a processor of a receiver device to perform operations comprising:
determining a high watermark margin and a low watermark margin for a cache of the receiver device based on data associated with a media instance to be downloaded; and
controlling download of portions of the media instance to the cache of the receiver device based at least in part on the determined high watermark margin and the determined low watermark margin.

25. The non-transitory processor-readable storage medium of claim 24, wherein the stored processor-executable instructions are configured to cause a processor of a receiver device to perform operations such that determining a high watermark margin and a low watermark margin for the cache of the receiver device based on data associated with the media instance to be downloaded comprises:
determining a playback rate of the media instance based on data associated with the media instance in response to receiving a media instance selection indication;
determining the high watermark margin for the cache of the receiver device based on a high watermark margin time value and the determined playback rate of the media instance; and
determining the low watermark margin for the cache of the receiver device based on a low watermark margin time value and the determined playback rate of the media instance,
wherein the high watermark margin time value and the low watermark margin time value are based at least in part on an abort pattern associated with the media instance or the receiver device.

26. The non-transitory processor-readable storage medium of claim 24, wherein the stored processor-executable instructions are configured to cause a processor of a receiver device to perform operations such that determining the high watermark margin and a low watermark margin for a cache of the receiver device based on data associated with the media instance to be downloaded comprises:
determining a playback rate of the media instance based on data associated with the media instance in response to receiving a media instance selection indication;
determining a low watermark margin for the cache of the receiver device based at least in part on a rate of change in buffered portions of the media instance in the cache of the receiver device; and
determining the high watermark margin for the cache of the receiver device based at least in part on the low watermark margin and the determined playback rate.

27. The non-transitory processor-readable storage medium of claim 26, wherein the stored processor-executable instructions are configured to cause a processor of a receiver device to perform operations such that determining the high watermark margin for the cache of the receiver device based at least in part on the low watermark margin and the determined playback rate comprises determining the high watermark margin for the cache of the receiver device based at least in part on an abort pattern coefficient, the low watermark margin, and the determined playback rate.

28. The non-transitory processor-readable storage medium of claim 27, wherein the stored processor-executable instructions are configured to cause a processor of a receiver device to perform operations such that determining the low watermark margin for the cache of the receiver device based at least in part on a rate of change in buffered portions of the media instance in the cache of the receiver device comprises determining the low watermark margin for the cache of the receiver device based at least in part on a rate of change in buffered portions of the media instance in the cache of the receiver device and the abort pattern coefficient.

29. The non-transitory processor-readable storage medium of claim 27, wherein the stored processor-executable instructions are configured to cause a processor of a receiver device to perform operations further comprising determining the abort pattern coefficient based on usage statistics of the receiver device.

30. The non-transitory processor-readable storage medium of claim 27, wherein the stored processor-executable instructions are configured to cause a processor of a receiver device to perform operations further comprising receiving the abort pattern coefficient from a server, wherein the abort pattern coefficient is based at least in part on usage statistics of other receiver devices.
